(19) United States
(12) Patent Application Publication
(10) Pub. No.: US 2011/0145071 A1
(43) Pub. Date: Jun. 16, 2011

(54) Domestic Billboard Apparatus and Communication Method Using the Same

(76) Inventors: Kshirsagar CJ Naidu, Ottawa (CA); Shruti CJ Naidu, Ottawa (CA); Sucheta CJ Naidu, Ottawa (CA); Prakash CRJ Naidu, Ottawa (CA)

(21) Appl. No.: 12/967,473

(22) Filed: Dec. 14, 2010

Related U.S. Application Data
(60) Provisional application No. 61/286,377, filed on Dec. 15, 2009.

(51) Int. Cl. G06Q 30/00; G09G 5/00

(52) U.S. Cl. 705/14.66; 705/28; 345/156

(57) ABSTRACT

A domestic billboard apparatus, communication, and business methods using the same are disclosed. The apparatus provides for viewing of content of personal interest to a household member such as family photographs, and along with that enables communication of advertisement flyers and messages related to products and services. The apparatus further provides for alternate means of communication from public services with a household such as pictorial representation of emergency procedures. The business methods using the apparatus relate to sales promotion, advertisement of products and services, and goodwill. The disclosure has potential for reduction of paper flyers contributing to environmental protection.

### RELATED U.S. PROVISIONAL PATENT APPLICATION

This application claims the benefit of U.S. Provisional Patent Application No. 61/286,377, filed Dec. 15, 2009, including all the written description of the inventions described therein and making claim to the inventions disclosed therein.

### BACKGROUND OF THE INVENTION

This invention relates to display based utility, communication, and associated business method, more particularly to a multi-purpose domestic electronic billboard.

Billboards are known outdoor display means for communicating messages to an audience. The messages may include advertisements, news, and other media. Sponsors of the messages such as advertisements are the sellers of related products or services. The sellers are interested to communicate such messages to as broad as possible audience to promote sales of their products or services. As the audience does not generally actively seek the information in the messages, the messages are configured to attract the attention of the audience. To achieve this objective, the advertisements sometimes include some content that may be of more specific interest to the receiver such as news, weather, temperature, etc. Bailey and Bailey (US Patent Application Pub. No. 2007/0277413 A1 dtd. Dec. 6, 2007) disclose extending this incentive to dispensing an item either free or at a reduced price by providing a dispensing device in proximity to the billboard display. The contents of disclosure and the references listed therein are adopted herein in total by reference. One preferred item dispensed as incentive in the disclosure is providing for free or reduced cost telephone calls which has been disclosed as an incentive for continued play at slot gaming machines (Walker et al, U.S. Pat. No. 7,101,282 B2 dtd. Sep. 5, 2006).

The billboards in prior art and the associated business methods disclosed have several limitations. By placing a billboard in public places such as a city center, a street corner, a mall, or a shopping complex, it is hoped that a targeted audience will notice the message communicated. However, it is well recognized that there is no way to ensure that the audience who may be really interested in a product or service are visiting such a place, noticing the message, and moreover noticing it repeatedly in order to register the message in the mind. Although providing an incentive through dispensing an item or a service such as free or reduced cost phone calling may improve the ability to attract the audience, these items or services may not be of interest to the particular potential customers. Further, the customers do not have a choice in deciding the content of the incentives provided. For example, a customer with a mobile phone may not find the phone calling incentive attractive. Moreover, the billboards continue to be located at public places even with incentive provisions which costs money as either space is to be rented, leased, or owned. Furthermore, the update of the message is not conveniently possible because the billboards located at different places may have to be physically visited by service personnel to revise the content being displayed.

The only current means of reaching an audience within a home directly to communicate a message are television, internet enabled computer, and phone. Out of these, visual content that is usually communicated through a billboard is possible only through the television or internet. Both these mediums do not provide targeted exposure to the message and thus it can not be ensured that the message reaches the intended receivers. For example, advertisements on television in spite of being expensive may not be viewed by the intended audience as there is no way to ensure that the channel on which an advertisement is broadcasted is viewed by the target audience. Information in internet has to be actively searched by a receiver; otherwise it stays in the huge body of information if the target audience does not actively seek for the same. Although electronic flyers are available on the web sites of the providers of products and services, they may not reach the intended audience unless they make a conscious effort to seek for the same. Electronic flyers are also sent through emails but are often ignored or deleted without being viewed by the intended audience. Pop-ups may be considered as equivalent to a billboard function in the cyberspace. However, pop-ups are generally blocked by internet users and also as their contents are difficult to match with the tastes and interests of the target audience; it is difficult to ensure that they may be viewed by the actual intended audience. These are some of the reasons why providers of products and services continue to spend considerable amounts in conventional outdoor billboards and in distribution of paper based conventional flyers to homes.

Aspects of the present invention overcome some of the difficulties in prior art either individually or in combination with each other. The advantages of the present invention will become apparent from the description and accompanying drawings.

### BRIEF SUMMARY OF THE INVENTION

A domestic billboard apparatus is disclosed comprising an electronic display, an electronic storage, a communication receiver, a controller, and user interface. The apparatus may be an electronic billboard that is a dual purpose system comprising display of at least one item of personal choice and interest to a household member such as an electronic photo album that additionally brings electronic flyers of local area business products and services into people's homes through easy to use display, communication device and interface. The apparatus can fulfill the need that may be appreciated by those in the field of marketing and advertisement that generally a target audience may not put a conscious effort to seek for information about a product or service but typically may absorb the same if exposed to the information subconsciously or involuntarily, preferably in a repeatable manner. More preferably, but optionally, the apparatus fulfills the desirable need that the information has better chances to be received by the viewer if it is sandwiched with other content of personal interest to the individual viewer. Moreover, this may enable reduction or substitution of paper based flyers resulting in saving of paper, and thus may contribute to environment protection. Furthermore, optionally the apparatus may provide an alternative channel of communication from the city to households. Associated business methods are disclosed wherein advertisement and sales promotion by an Internet Service Provider or a seller of a product or service may offer the domestic billboard apparatus for at least one of a free and a reduced price as an incentive to subscribe or buy and subsequently use the billboard for advertisement through communication of electronic flyers.

### BRIEF DESCRIPTION OF THE SEVERAL VIEWS OF THE DRAWING

FIG. 1 shows the front elevation view of an embodiment of the domestic billboard apparatus, and FIG. 1A is a side view as seen from the right of the apparatus.

FIG. 2 is an embodiment of overall system configuration of the functional sub-systems inside the domestic billboard apparatus.

FIG. 2A illustrates one of the variants of the domestic billboard apparatus built as prototype showing the main components of the functional sub-systems.

FIG. 3 shows the flowchart of a business method that provides a domestic billboard apparatus as an incentive to subscribe internet service and further uses the same for advertisement through communication of electronic flyers.

FIG. 4 shows the flowchart of a business method that provides a domestic billboard apparatus as an incentive to buy a product or a service and further uses the same for advertisement through communication of electronic flyers.

FIG. 5 shows the flowchart of a business method that provides a domestic billboard apparatus as an incentive to subscribe internet service and further collaborates with a seller of a product or a service for advertisement and sales promotion.

FIG. 6 shows the flowchart of a business method that provides a domestic billboard apparatus as an incentive to subscribe internet service and further collaborates with a public service for communicating a matter of interest to a household.

FIG. 7 shows the flowchart of a business method that provides a domestic billboard apparatus as an incentive to buy a product or a service and further collaborates with a public service for communicating a matter of interest to a household.

### DETAILED DESCRIPTION OF THE INVENTION

The disclosed domestic billboard apparatus overcomes the difficulties in the prior art by providing a means to display messages directly to the target audience at their residence along with the display of content of choice and interest of the audience.

A preferred embodiment 100 of the domestic billboard apparatus showed in FIG. 1 has a frame 110 that holds a display 120. The display may be a LCD display or other electronic means of display capable of displaying electronic flyers, digital photographs, and other images such as text and pictorial messages. Additionally, but optionally, provision for audio communication of messages along with pictorial representation on the display may be provided to complement the display (not shown in the Fig.). An antenna 130 receives wireless communication (for example by Wi-Fi™, GSM™, others) from the internet through the router in the home, or directly from a source. A user interface 140 provides function buttons and keys such as on-off, mode selector providing for selection of mode of display such as flyer viewer mode or album viewer mode, grocery viewer mode or any other mode of interest to a user household member, scroll from one display to another, pause, and slide show. An input-output interface 150 provides means such as USB™ port to upload content of interest. For example, digital photographs of interest to a person or several persons in the household may be uploaded from a camera into the billboard apparatus. Further, ports may enable download of content of interest into other devices. For example, items of interest to a person in the household may be selected and downloaded into a mobile device such as a cellular phone or PDA to enable a digital shopping list to be taken by the person to the shop. FIG. 1A is a side view as seen from the right of the apparatus. It may be appreciated by those skilled in the art that the locations of antenna, user interface, and input-output interface as shown in the figures is only representative of an example preferred embodiment, and there can be several alternate locations for their placement, for example, on top, or on back. It is further possible to embed the user interface within the display 120 by use of touch screen display.

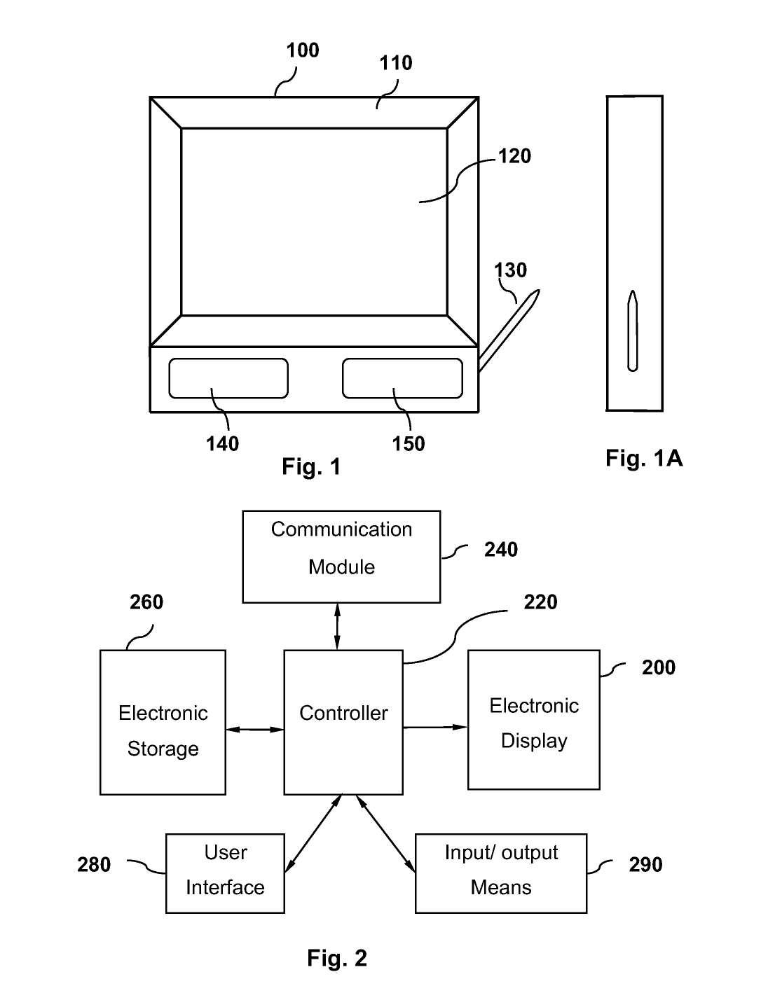

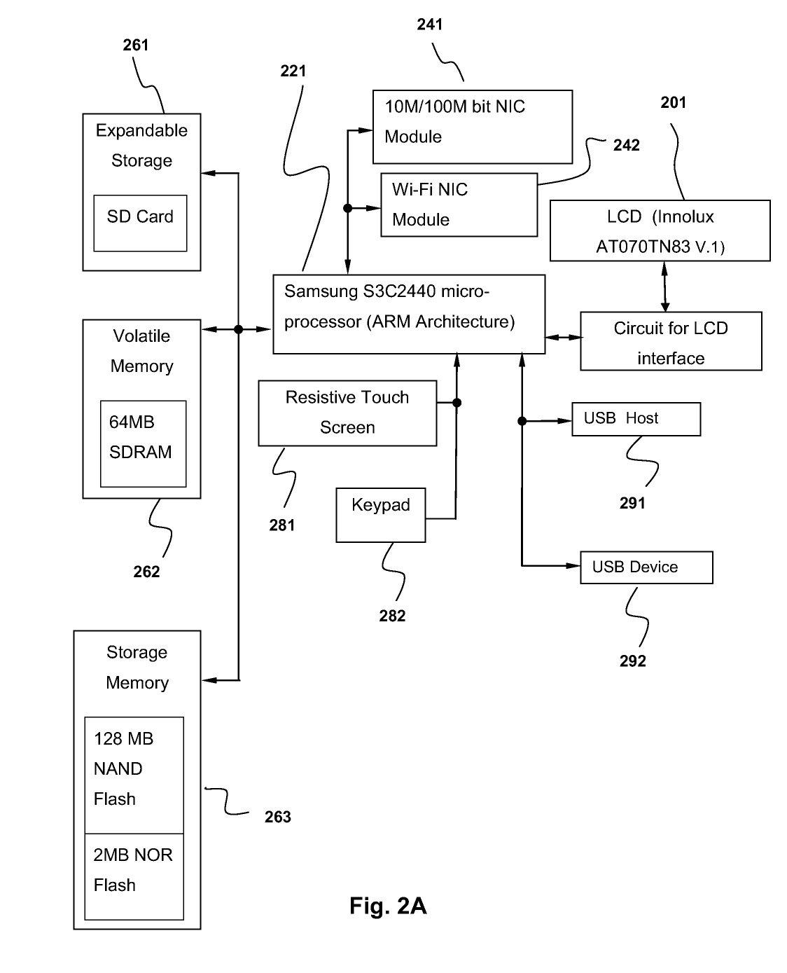

The schematic of the internal functioning units of the domestic billboard apparatus shown in FIG. 2 comprises an electronic display 200 that receives the display information through a controller 220.

The electronic display may be a Liquid Crystal Display (LCD) display or any other means to portray information, in particular pictorial or graphic information along with text in electronic form. The LCD display may be direct or indirect adaptations, customizations, or extensions of displays available for other purposes such as digital photo frames (for example, Dynex 7″ Digital Picture Frame DX-DPF7WA09CA, Dynex™ Products, MN, USA). While LCD displays are the most likely form of display currently, the older Cathode Ray Tube (CRT) displays or emerging displays such as E-Paper flexible display arranging Thin-Film Transistors (TFT) on flexible and bendable plastic sheet or metal foil (for example, from LG Philips LCD, Seoul, S. Korea) or any further developments in display products are intended to be utilized as the electronic display for the domestic billboard apparatus.

The controller 220 may be a computer, embedded computer, system-on-chip (SOC), a micro-controller, a microprocessor, a digital signal processor, a Field Programmable Gate Array (FPGA), any circuit means or any variant or combination of these that can be used as a means to interact with a communication receiver 240, an electronic storage unit 260, a user interface 280, and an Input/Output means 290. The controller hosts the operating system, handles devices through drivers, functions to analyze information and coordinates the action based on data stored in the storage unit, input requests, and output requests through the user interface. Examples of functions include display scrolling enabling choice of viewing of particular area of display content, display zooming enabling choice of enlarged viewing of particular area of display content, and extraction of information of interest of the user from an electronic flyer. The controller may further receive information about items purchased and stocked in the household that is stored in the electronic storage unit 260 (based on scanned or input information), analyze the information, generate and display warning messages about expiry dates of the items that may appear on the electronic display 200. The controller may be stand alone sub-system or embedded system. The software may be generic (such as Windows™ or Linux™) or a firmware or other embedded software.

The communication module 240 may be a receiver or transreceiver comprising of currently available technology or enhancements. For example, it may be a modem providing for wired connection through a Local Area Network (LAN) or a wireless connection to internet. The scope of connectivity to internet may be the World Wide Web, other group networks, for example, Voice over Internet Protocol (VoIP) network such as Skype™ protocol or a local service network that provides product or service advertisement information, emergency or other public service information or the like. Products available in market that combine the communication receiver 240 with LCD display 200 may be advantageously adopted with customization or extension (for example, Photo Frame product HP® sd828a1 8″, 800×600 Smart Wi-Fi Display or HP® DreamScreen™ 100, Hewlett-Packard Company, Palo Alto, Calif., USA).

The electronic storage 260 may be a magnetic disk, mini-disk, magnetic tape, a card, a USB flash drive, optical disc such as CD or DVD, or a solid state data storage device.

The user interface 280 may comprise of switch to on-off, buttons to input characters or other information or to manipulate the displayed images, keypad to input numerals, touchpad, touch screen, scrolling interface, joystick and other such means or their combinations, for example, mode selector providing for selection of mode of display such as flyer viewer mode or album viewer mode, grocery viewer mode or any other mode of interest to a user household member, scroll from one display to another, pause, and slide show. The display scrolling means may enable choice of viewing of particular area of display content. The user interface may also include a display zooming means enabling choice of enlarged viewing of particular area of display content. The user interface may in addition, but optionally include a means to initiate and implement extraction of information of interest, for example, a shopping list of the items of interest from a flyer. It may be appreciated by those skilled in the art that the user interface may implement currently available means but may upgrade as and when newer means become available technologically. For example, currently scrolling from one flyer page to another may be by repeated pressing of a button with arrow symbol in the direction of scroll (up-down or left-right); but may upgrade to gesture based scroll in which the billboard apparatus may detect the motion of the user's hand in front of the billboard in certain direction to scroll from one page to another.

Input/output means 290 include ports such as USB™ port, memory card slot (e.g., for MicroSD™); or other means such as wireless, e.g., Bluetooth™, Infrared (IrDA™) or enhancements such as Very Fast Infrared (VFIR), IRSimple (a protocol that is enabling a recent comeback of Infrared Data Association based transreceiving by providing for transfer of pictures between cell phones and display devices in less than a second), or other transmission means that provides for data to be input to or output from the domestic billboard apparatus. For example, a USB™ input port may provide for connection of a digital camera with the domestic billboard apparatus enabling downloading of digital images into the apparatus. A keypad or a barcode scanner or a vision based scanner or voice recognition based means may enable receiving information about items purchased and stocked in the household. A USB™ output port may provide for connection of a cellular phone with the domestic billboard apparatus to upload a shopping list of the items of interest from a flyer. Further, the input/output means may be either wired or wireless.

It may be appreciated by those skilled in the art that there can be several variants of the configuration of the domestic billboard apparatus as described above, and it is intended that they are within scope and spirit of the invention outlined herewith. One of the variants of the configuration built as a prototype is illustrated in FIG. 2A and described as follows.

In this embodiment, the controller is a Samsung® S3C2440 processor 221 based on the ARM™ architecture, a low powered micro-processor device clocked at 400 MHz ideal for mobile devices. The controller 221 has access to 64 MB of SD-RAM volatile memory unit 262. On the motherboard holding micro-processor, there is non-volatile memory 263 for storing the boot-loader and operating system as well as other allocations. The boot-loader used is U-Boot and is stored on 2 MB NOR Flash. The operating system used for the prototype is an embedded Linux™ called Angstrom™ running Linux kernel version 2.6.34, which is stored on the 128 MB NAND Flash. Qt for Embedded Linux is also loaded along with Angstrom™. Applications for the prototype are designed using Qt Framework.

The data storage capacity of the domestic billboard apparatus prototype is expandable. For extended storage 261, a SD-Card reader is provided. A SD-Card can be inserted into the slot and can be used by the operating system to read data from or write data to.

Two Input/Output modules are provided in the prototype, one being a USB Host module 291, and the other being a USB Device module 292.

There are two means for the prototype device to connect to the internet. One is via Ethernet using the 10M/100M bit NIC Module 241, and the other by means of Wi-Fi connection using the Wi-Fi NIC Module 242.

User Interface comprises a resistive touch screen module 281, and a keypad module 282. User Interface is provided by either of the two means, or by a combination of both.

The electronic display in the prototype is an Innolux AT070TN83 LCD V.1 display 201. It is a 7″ RGB color display with pixel resolution of 800×480.

The domestic billboard apparatus is intended for use in different ways for business and commercial activity including facilitation of communication with user. A few of the preferred business methods are as following.

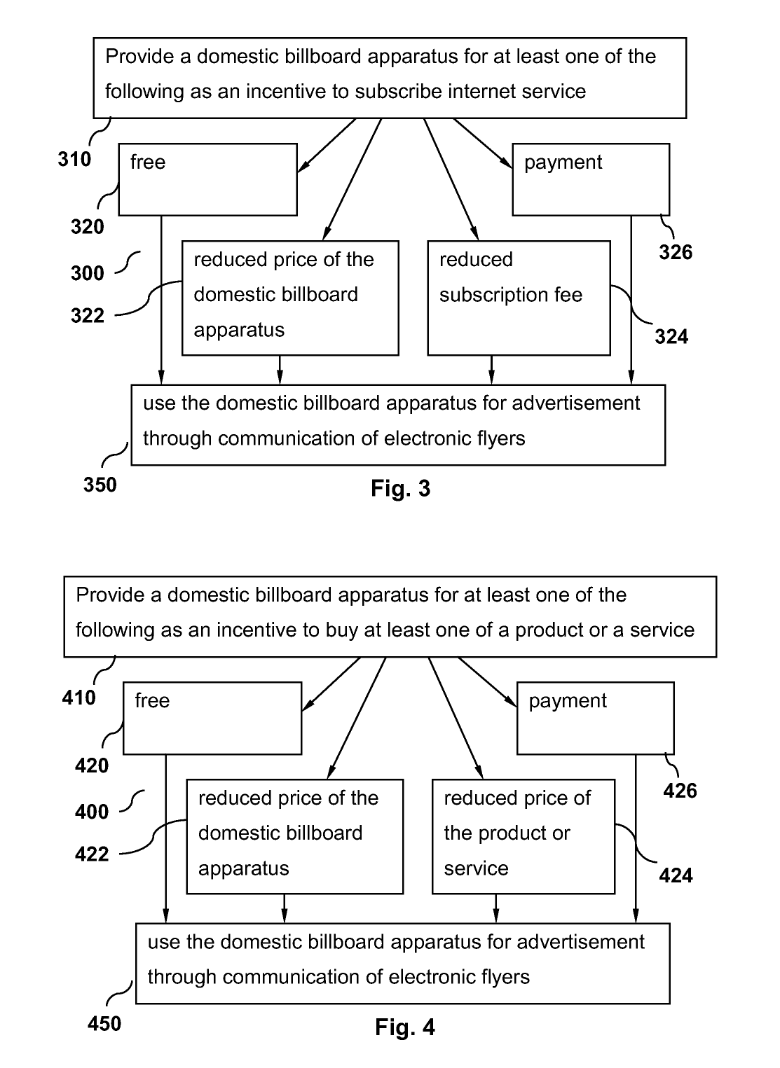

The business method 300 presented in FIG. 3 provides a domestic billboard apparatus (step 310) for at least one of several possible considerations as an incentive to subscribe internet service. The possible considerations may include no cost for the domestic billboard apparatus (step 320), reduced or discounted price of the domestic billboard apparatus (step 322), reduced subscription fee for the internet service (step 324), or either for a premium payment charged for the apparatus and service as an additional option or an additional payment made along with no cost for the domestic billboard apparatus as an incentive to install the apparatus in the household (step 326). A suitable approach out of these may be selected and employed based on a campaign objective, the strategic plans, potential and affordability of particular target market segment, or any other business considerations. An incentive and motivation for a household or a person in a household who is a potential consumer of internet service is use of the apparatus acquired through any of the aforementioned schemes for viewing an item of personal interest and choice, for example, photographs in the form of digital images of self, family, friends, occasions, events, or any other content such as natural scenes, or celebrities. This is likely to increase the demand and therefore sales of the internet service. In addition, once the apparatus is installed in the household, it can subsequently be used for advertisement through communication of electronic flyers (step 350). This is achieved by the ability of the domestic billboard apparatus to get connected to the internet or a LAN either through wired or wireless connection and download the flyers specified either by the internet service provider or another party that represents the service provider.

The business method 400 presented in FIG. 4 is a variant of the preceding method that provides a domestic billboard apparatus (step 410) for at least one of several possible considerations as an incentive to buy at least one of a product or a service. The possible considerations may include no cost for the domestic billboard apparatus (step 420), reduced or discounted price of the domestic billboard apparatus (step 422), reduced price of the product or service (step 424), or either for a premium payment charged for the apparatus and service as an additional option or an additional payment made along with no cost for the domestic billboard apparatus as an incentive to install the apparatus in the household (step 426). A suitable approach out of these may be selected and employed based on a campaign objective, the strategic plans, potential and affordability of particular target market segment, or any other business considerations. An incentive and motivation for a household or a person in a household who is a potential consumer of a product or service is again use of the apparatus acquired through any of the aforementioned schemes for viewing an item of personal interest and choice, for example, photographs in the form of digital images of self, family, friends, occasions, events, or any other content such as natural scenes, or celebrities. This is likely to increase the demand and therefore sales of the product or service. In addition, once the apparatus is installed in the household, it can subsequently be used for advertisement through communication of electronic flyers (step 450). This is achieved by the ability of the domestic billboard apparatus to get connected to the internet or a LAN either through wired or wireless connection and download the flyers specified either by the product or service provider, or another party that may represent the interests of the product or service provider such as advertisement and marketing entities.

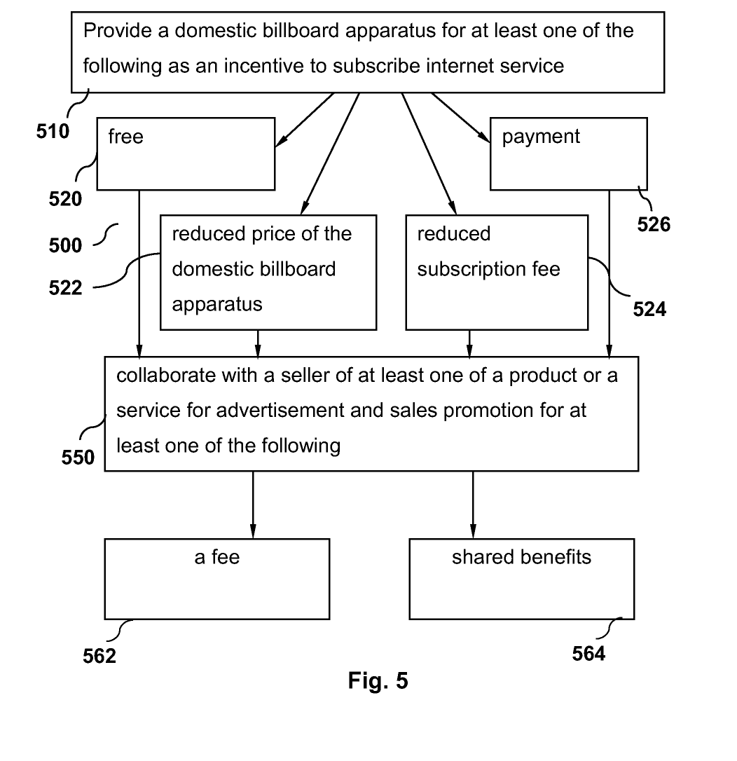

The business method 500 presented in FIG. 5 is another variant of the method of FIG. 3. It provides a domestic billboard apparatus (step 510) for at least one of several possible considerations as an incentive to subscribe internet service. The possible considerations may include no cost for the domestic billboard apparatus (step 520), reduced or discounted price of the domestic billboard apparatus (step 522), reduced subscription fee for the internet service (step 524), or either for a premium payment charged for the apparatus and service as an additional option or an additional payment made along with no cost for the domestic billboard apparatus as an incentive to install the apparatus in the household (step 526). A suitable approach out of these may be selected and employed based on a campaign objective, the strategic plans, potential and affordability of particular target market segment, or any other business considerations. As indicated earlier, an incentive and motivation for a household or a person in a household who is a potential consumer of internet service is use of the apparatus acquired through any of the aforementioned schemes for viewing an item of personal interest and choice, for example, photographs in the form of digital images of self, family, friends, occasions, events, or any other content such as natural scenes, or celebrities. This is likely to increase the demand and therefore sales of the internet service. In addition, in this method, once the apparatus is installed in the household, it can subsequently be used for advertisement and sales promotion through communication of electronic flyers in collaboration with a seller of at least one of a product or a service (step 550) either for a fee (step 562) or for the consideration of sharing of benefits or returns (step 564). This is again achieved by the ability of the domestic billboard apparatus to get connected to the internet or a LAN either through wired or wireless connection and download the flyers specified either by the internet service provider or another party that represents the service provider.

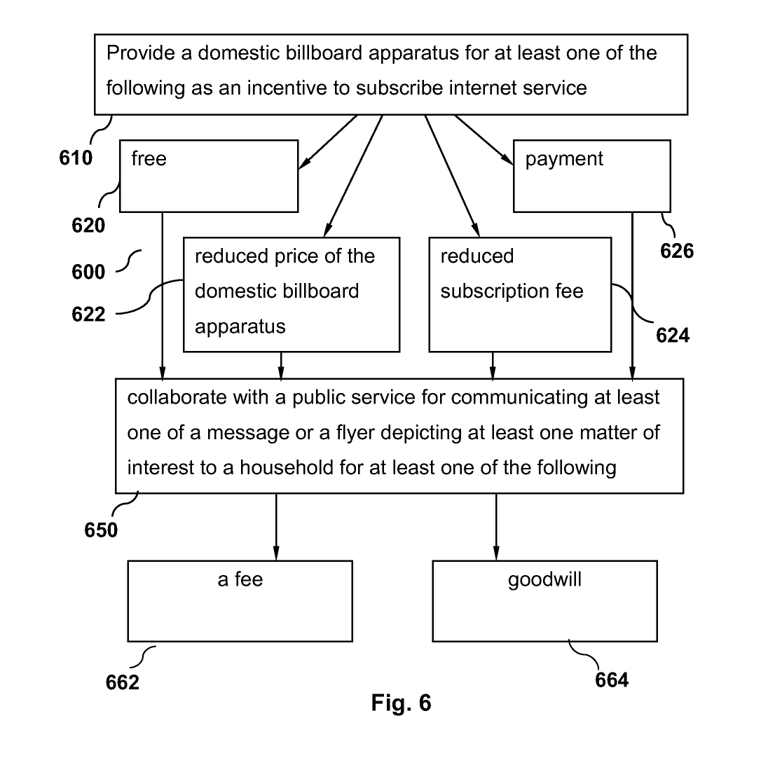

The business method 600 presented in FIG. 6 is a further variant of the method of FIG. 5. It again provides a domestic billboard apparatus (step 610) for at least one of several possible considerations as an incentive to subscribe internet service. The possible considerations may again include no cost for the domestic billboard apparatus (step 620), reduced or discounted price of the domestic billboard apparatus (step 622), reduced subscription fee for the internet service (step 624), or either for a premium payment charged for the apparatus and service as an additional option or an additional payment made along with no cost for the domestic billboard apparatus as an incentive to install the apparatus in the household (step 626). A suitable approach out of these may be selected and employed based on a campaign objective, the strategic plans, potential and affordability of particular target market segment, or any other business considerations. As indicated earlier, an incentive and motivation for a household or a person in a household who is a potential consumer of internet service is use of the apparatus acquired through any of the aforementioned schemes for viewing an item of personal interest and choice, for example, photographs in the form of digital images of self, family, friends, occasions, events, or any other content such as natural scenes, or celebrities. This is likely to increase the demand and therefore sales of the internet service. In addition, in this method, once the apparatus is installed in the household, it can subsequently be used for communication of electronic flyers or messages depicting a matter of interest to a household in collaboration with a public service (step 650) either for a fee (step 662) or for the consideration of goodwill (step 664). This is again achieved by the ability of the domestic billboard apparatus to get connected to the internet or a LAN either through wired or wireless connection and download the flyers and messages communicated from the public service and facilitated either by the internet service provider or another party that represents the service provider. In addition to the other business methods discussed, the apparatus through this business method may provide, for example, an alternate channel of communication between city emergency services in the community (911 calls) and the households that may benefit more by communication of a pictorial representation of an emergency first aid procedure in a flyer form. For example, high risk households such as old homes or households having senior citizens with hearing and/or text reading weaknesses, new immigrant households that may have persons with language or accent comprehending challenges can be priority users who may benefit by the apparatus through this business method. Other examples are the communication from the city or community or local administration about health warnings, weather warnings, snow removal schedule changes, school bus cancellation, any other alerts, warnings, reminders, or information of interest and utility to a household.

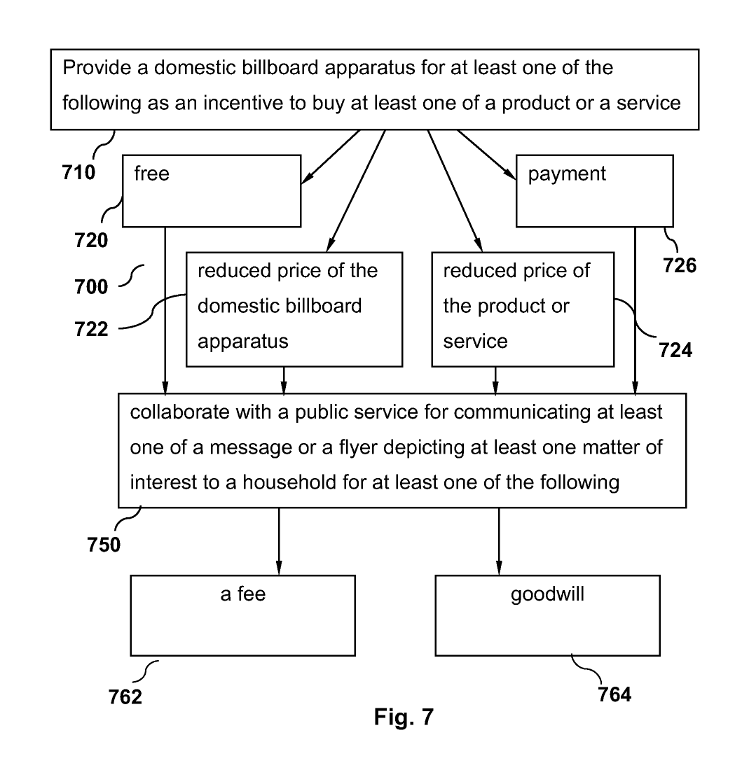

The business method 700 presented in FIG. 7 is an additional variant of the method of FIG. 4. It again provides a domestic billboard apparatus (step 710) for at least one of several possible considerations as an incentive to buy at least one of a product or a service. The possible considerations may again include no cost for the domestic billboard apparatus (step 720), reduced or discounted price of the domestic billboard apparatus (step 722), reduced price of the product or service (step 724), or either for a premium payment charged for the apparatus and service as an additional option or an additional payment made along with no cost for the domestic billboard apparatus as an incentive to install the apparatus in the household (step 726). A suitable approach out of these may be selected and employed based on a campaign objective, the strategic plans, potential and affordability of particular target market segment, or any other business considerations. As indicated earlier, an incentive and motivation for a household or a person in a household who is a potential consumer of the product or service is use of the apparatus acquired through any of the aforementioned schemes for viewing an item of personal interest and choice, for example, photographs in the form of digital images of self, family, friends, occasions, events, or any other content such as natural scenes, or celebrities. This is likely to increase the demand and therefore sales of the product or service. In addition, in this method, once the apparatus is installed in the household, it can subsequently be used for communication of electronic flyers or messages depicting a matter of interest to a household in collaboration with a public service (step 750) either for a fee (step 762) or for the consideration of goodwill (step 764). This is again achieved by the ability of the domestic billboard apparatus to get connected to the internet or a LAN either through wired or wireless connection and download the flyers and messages communicated from the public service and facilitated either by the product or service provider or another party that represents the product or service provider or another party that may represent the interests of the product or service provider such as advertisement and marketing entities. In addition to, optionally, or alternatively to the business method discussed in FIG. 4, the apparatus through this business method may provide, for example, an alternate channel of communication between city emergency services in the community (911 calls) and the households that may benefit more by communication of a pictorial representation of an emergency first aid procedure in a flyer form. For example, in a typical phone based communication between a medical emergency caller and responder, the voice based message from the responder is heard and interpreted only by one person in the household making the emergency call. The first aid steps to be taken till the emergency help arrives is understood and interpreted only by that one person in the household who has communicated with the responder. Any misunderstanding or misinterpretation may be critical. Moreover, the other persons in the household or any other person who may arrive in the scene has to get the message about the steps to be taken from that first communicator only, further increasing the chances of distortion of the message as it is well known that a chain of human communication is prone to distortion. The communication received on the domestic billboard apparatus in the form of a written message or pictorial message may either independently or as a complementary means to voice message overcome these difficulties. High risk households such as old homes or households having senior citizens with hearing and/or text reading challenges, new immigrant households that may have persons with language or accent comprehending challenges can be priority users who may benefit by the apparatus through this business method. Other examples are the communication from the city or community or local administration about health warnings, weather warnings, snow removal schedule changes, school bus cancellation, any other alerts, warnings, reminders, or information of interest and utility to a household.

It may be appreciated by those skilled in the art that the business methods discussed may have different modes of implementation with different configurations of features in the hardware and the software functioning of the preferred embodiments. For example, an advertisement and sales campaign may include levels of sales of products or services based on which a purchaser becomes eligible for a free or discounted domestic billboard apparatus. As an illustration, a certain amount of purchasing over a period of time may make a person or household eligible for free or discounted apparatus. Furthermore, it may be advantageous to fix levels of features based on the amount of purchasing over a period of time. For example, if a person or household spends a lower level of amount in purchase of products or services, eligibility for free or discounted apparatus may be limited to a version of the apparatus that does not have mode selector option in the interface of the apparatus. This may be preferable for the product or service provider as without mode selection option in the apparatus, the person or household would view the content of the flyers in-between the slide show of content of personal interest such as photos of family, thus fulfilling the advertisement objectives to a higher extent. If a person or household spends a higher level of amount in purchase of products or services, eligibility for free or discounted apparatus may be enhanced to a version of the apparatus that has mode selector option in the interface of the apparatus. This may be less preferable for the product or service provider as with the mode selection option in the apparatus, the person or household would not view the content of the flyers in-between the slide show of content of personal interest such as photos of family, thus fulfilling the advertisement objectives to a lesser extent; however, the higher amount in purchase of products or services spent upfront by the person or household may offset partially or fully the reduced exposure to advertisements. Moreover, such a person or household is likely to view the advertisement flyers even with mode selector option by putting the extra effort of switching the mode from personal content mode to the flyer mode voluntarily with reasonable frequency as the person or household has demonstrated in advance an interest or loyalty in the products or services of the provider by spending the higher amount in purchase of products or services upfront. All such variants and extensions of business methods may be considered as within the spirit and scope of this disclosure.

It may be further appreciated that future developments such as provision of free access internet connectivity in a city or community may change the disclosed business methods, and suitable adaptations may be necessary. For example, if free connectivity is available, the business methods may have lesser or no role of Internet Service Providers and may increase more direct communication between a product or service provider or their representative such as a marketing or advertisement service provider and user household that may have the domestic billboard apparatus.

To demonstrate the advantage of the proposed business methods, a specific implementation example is discussed. Consider that the domestic billboard apparatus called FlyWizer™ is provided to a pilot batch of user households in a target community (the user) that may be having a population of about half a million with number of households as 180,000. Further, considering a 10% market penetration, the number of domestic billboards can be 18,000. With the estimated cost of each FlyWizer™ as $200, a 25% mark up will result in price of the apparatus as $250, revenue of $4.5 million and a margin of $0.9 million for the supplier of domestic billboard apparatus. Suppose a campaign by a product or service provider distributes the domestic billboard apparatus to users at 50% subsidy, the required investment is $2.25 million. Considering the cost of printing a two sided 8.5 inch×11 inch 4-color flyer as $1000 for 18000 flyers, typical weekly flyer set with printed paper equivalent to 10 such sheets may cost $10,000; and further considering other costs for reaching most of the households weekly as 100% of printing cost, the total weekly expenses amounts to $20,000. Therefore, the yearly cost is estimated as $1.04 million. This demonstrates the investment in domestic billboard apparatus as equivalent to expenses incurred in conventional paper flyers over a break even period of between 2 to 2.5 years. As the life of the apparatus is expected to be around 5 years similar to most electronic display devices, continued functioning beyond 2.5 years is expected to result in savings for the product or service provider. Furthermore, the environmental impact of the apparatus by reduction or elimination of conventional paper flyers will be beneficial. For example, considering that paper of 20 pounds basis weight is used that weighs 10 pounds per 1000 sheets of 8.5 inch by 11 inch size, an annual saving of 93,600 pounds of paper can result in the half million population community alone with just the 10% target penetration. It may be appreciated that if the implementation expands to the households of approximately 340 million populations of USA and Canada, the environmental impact in terms of reduction of usage of paper can be significant. In addition to providing the domestic billboard apparatus on a subsidized price, the product or service provider businesses in the target community may commit not to distribute free flyers anywhere in the community and to introduce a small fee (such as 5 cents) per flyer as a deterrent similar to how some businesses are charging now for plastic bags, further reducing the use of paper flyers and thus contributing to environmental protection. It may be appreciated by those skilled in the art and the business that the figures indicated in these examples are only for illustrative understanding of the business method and its beneficial impacts, and the figures can change substantially depending on different factors such as scale of implementation of the business methods and consequent scale of production quantities. For example, a large scale implementation may make it possible to reduce the estimated cost of the apparatus likely by considerable amount, decreasing the break even period, and increasing the distribution; varying the total cost, marginal cost, and total revenues along with adoption of suitable production approaches such as offshore manufacturing of the customized domestic billboard apparatus.

The location of the domestic billboard may be anywhere inside a household as against a public place in case of conventional billboard. Within the household, more specifically but optionally, the location may depend on the product or service intended to be advertised on the billboard. For example, if groceries and food items are intended to be advertised by offering of the apparatus by a grocery or food vendor, the billboard may be located in a convenient position in the kitchen. In this case, the billboard may be customized with additional sealing and ruggedness to work in an environment with oil fumes that may be present in the kitchen.

It may be appreciated by those skilled in the art that the meaning of domestic includes different situations extending to an office or works environment in which catalog sheets of products generally referred to by certain department may represent equivalency of electronic flyer of a product or service and in such a situation the domestic billboard may become an office billboard located in the relevant department and thus preferably assuming the term office billboard instead of domestic billboard. The associated business method in such a context may involve advertisement and sales promotion by a seller of an industrial product or service who may offer the office billboard apparatus for at least one of a free and a reduced price as an incentive to buy and subsequently use the billboard for advertisement through communication of electronic catalog sheets. The apparatus may be in such a case an electronic billboard that is a dual purpose system comprising display of at least one item of personal choice and interest to an office member such as an electronic photo album or a digital calendar or digital technical information aid such as a formula or reference data sheet aid helpful for the office member in day to day work. The apparatus may additionally bring electronic catalog sheets of relevant business products and services into the offices at the work location through easy to use display, communication device and interface. This may again enable saving of paper by reducing or avoiding supply of catalogs and product literature, and thus contribute to environment protection.

We claim:

1. A domestic billboard apparatus comprising:
an electronic display;
an electronic storage;
a communication receiver;
a controller; and
a user interface.

2. The domestic billboard apparatus of claim 1 further comprising a display mode selector enabling choice of display content.

3. The domestic billboard apparatus of claim 1 further comprising a display scrolling means enabling choice of viewing of particular area of display content.

4. The domestic billboard apparatus of claim 1 further comprising a display zooming means enabling choice of enlarged viewing of particular area of display content.

5. The domestic billboard apparatus of claim 1 further comprising an extractor of information of interest.

6. The domestic billboard apparatus of claim 5 further comprising a means to download the information of interest to a mobile device.

7. The domestic billboard apparatus of claim 1 further comprising a means to receive information about items purchased and stocked in the household, store the information, analyze the information, generate and display warning messages about expiry dates of the items.

8. A method of communication providing a domestic billboard apparatus comprising:
display of at least one item of personal choice and interest of at least one member of the household;
display of at least one of a message or a flyer communicating information about at least one of a product or a service.

9. The method of claim 8, further comprising display of at least one of a message or a flyer depicting at least one matter of interest to a household communicated from a public service.

10. The method of claim 8, further comprising advertisement and sales promotion by an Internet Service Provider offering the domestic billboard apparatus for at least one of a free, or a reduced price of the domestic billboard apparatus, or a reduced subscription fee, or a payment; as an incentive to subscribe.

11. The method of claim 8, further comprising advertisement and sales promotion by an Internet Service Provider offering the domestic billboard apparatus for at least one of a free, or a reduced price of the domestic billboard apparatus, or a reduced subscription fee, or a payment; as an incentive to subscribe; and subsequently using the billboard for advertisement through communication of electronic flyers.

12. The method of claim 8, further comprising advertisement and sales promotion by a seller of at least one of a product or a service offering the domestic billboard apparatus for at least one of a free, or a reduced price of the domestic billboard apparatus, or a reduced price of the product or service, or a payment, as an incentive to buy; and subsequently using the billboard for advertisement through communication of electronic flyers.

13. The method of claim 8, further comprising advertisement and sales promotion by an Internet Service Provider offering the domestic billboard apparatus for at least one of a free, or a reduced price of the domestic billboard apparatus, or a reduced subscription fee, or a payment; as an incentive to subscribe, and in addition the Internet Service Provider collaborating with a seller of at least one of a product or a service for advertisement and sales promotion for at least one of a fee or shared benefits.

14. The method of claim 8, further comprising advertisement and sales promotion by an Internet Service Provider offering the domestic billboard apparatus for at least one of a free, or a reduced price of the domestic billboard apparatus, or a reduced subscription fee, or a payment; as an incentive to subscribe, and in addition the Internet Service Provider collaborating with a public service for communicating at least one of a message or a flyer depicting at least one matter of interest to a household for at least one of a fee or goodwill.

15. The method of claim 8, further comprising advertisement and sales promotion by a seller of at least one of a product or a service offering the domestic billboard apparatus for at least one of a free, or a reduced price of the domestic billboard apparatus, or a reduced price of the product or service, or a payment; as an incentive to buy, and in addition the product or service provider collaborating with a public service for communicating at least one of a message or a flyer depicting at least one matter of interest to a household for at least one of a fee or goodwill.
